(19) United States
(12) Patent Application Publication
(10) Pub. No.: US 2024/0340362 A1
(43) Pub. Date: Oct. 10, 2024

(54) SEGMENT ROUTING INTEGRATED IN IN-BAND TELEMETRY CAPABILITY

(71) Applicant: 3nets.io, Inc., Santa Clara, CA (US)

(72) Inventors: Corneliu-Ilie Calciu, Bucharest (RO); Gavril-Ioan Florian, Chitila (RO); Ragho Mahalingam, Nashua, NH (US); Immanuel Rahardja, Fremont, CA (US); Abraham Pucheril, Highlands Ranch, CO (US)

(21) Appl. No.: 18/132,201

(22) Filed: Apr. 7, 2023

(51) Int. Cl. H04L 69/22; H04L 45/00

(52) U.S. Cl. CPC H04L 69/22; H04L 45/34

(57) ABSTRACT

A telemetry processing apparatus for telemetry processing in a transit node or an egress node includes a tag reader module configured to read a tag of a tag field of a segment routing header of a data packet received at a node along a communication pathway. The communication pathway is described in a segment list in the segment routing header. The telemetry processing apparatus includes an attribute module configured to identify from the tag an attribute set with one or more in-band telemetry attributes to be collected from the node, and a telemetry write module configured to write the in-band telemetry attributes of the attribute set to a location of a current segment address of a segment list of the segment routing header. The current segment address corresponds to the node.

### FIELD

This invention relates to in-band telemetry and more particularly relates to using segment routing fields for in-band telemetry.

### BACKGROUND

In data transmission, source routing is a routing technique used for traffic engineering and used to simplify the routing management. In-band network telemetry is a monitoring framework used to collect the data path attributes without intervention from a control plane. Data collected by in-band network telemetry can be used to assess the network service level agreement compliance and to identify the network elements or the network sections that perform outside the normal limits. However, some in-band telemetry techniques affect the bandwidth of data transmission. Other in-band telemetry techniques send telemetry packets at a sampling rate that may miss micro-bursts of data packets.

### SUMMARY

A telemetry processing apparatus for telemetry processing in a transit node or an egress node includes a tag reader module configured to read a tag of a tag field of a segment routing header of a data packet received at a node along a communication pathway. The communication pathway is described in a segment list in the segment routing header. The telemetry processing apparatus includes an attribute module configured to identify from the tag an attribute set with one or more in-band telemetry attributes to be collected from the node, and a telemetry write module configured to write the in-band telemetry attributes of the attribute set to a location of a current segment address of a segment list of the segment routing header. The current segment address corresponds to the node. At least a portion of the modules include hardware circuits, programmable hardware circuits and/or executable code where the executable code is stored on one or more non-transitory computer readable storage media.

A telemetry setup apparatus for telemetry setup in an ingress node includes a telemetry receiver module configured to receive, at an ingress node, telemetry instructions from a network controller. The telemetry instructions include an attribute set with one or more in-band telemetry attributes to be collected from nodes along a communication pathway from the ingress node to an egress node by data packets of a source routing packet flow traversing the communication pathway. The telemetry setup apparatus includes a tag field module configured to write a tag to a tag field of a segment routing header of a data packet of the source routing packet flow where the tag corresponds to the attribute set, and a packet transmission module configured to transmit the data packet to a destination IP address of a next node in the communication pathway. The destination IP address corresponds to a segment address from a segment list in the segment routing header of the data packet. At least a portion of the modules include hardware circuits, programmable hardware circuits and/or executable code. The executable code is stored on one or more non-transitory computer readable storage media.

A telemetry processing method for in-band telemetry processing includes reading a tag of a tag field of a segment routing header of a data packet received at a node along a communication pathway. The communication pathway is described in a segment list in the segment routing header. The telemetry processing method includes identifying from the tag an attribute set comprising one or more in-band telemetry attributes to be collected from the node, and writing the in-band telemetry attributes of the attribute set to a location of a current segment address of a segment list of the segment routing header where the current segment address corresponds to the node.

A telemetry setup method includes receiving, at an ingress node, telemetry instructions from a network controller. The telemetry instructions include an attribute set with one or more in-band telemetry attributes to be collected from nodes along a communication pathway from the ingress node to an egress node by data packets of a source routing packet flow traversing the communication pathway. The telemetry setup method includes writing a tag to a tag field of a segment routing header of a data packet of the source routing packet flow where the tag corresponds to the attribute set and transmitting the data packet to a destination IP address of a next node in the communication pathway. The destination IP address corresponds to a segment address from a segment list in the segment routing header of the data packet.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating a system for in-band telemetry, according to various embodiments;

FIG. 2 is a schematic block diagram illustrating an apparatus for telemetry processing in a transit node or an egress node, according to various embodiments;

FIG. 3 is a schematic block diagram illustrating another apparatus for telemetry processing in a transit node or an egress node, according to various embodiments;

FIG. 4 is a schematic block diagram illustrating an apparatus for telemetry setup in an ingress node, according to various embodiments;

FIG. 5 is a schematic block diagram illustrating another apparatus for telemetry setup in an ingress node, according to various embodiments;

FIG. 6 is a flowchart diagram illustrating a method for telemetry processing at a transit node or an egress node, according to various embodiments;

FIG. 7 is a flowchart diagram illustrating another method for telemetry processing at a transit node or an egress node, according to various embodiments;

FIG. 8 is a flowchart diagram illustrating a method for telemetry setup at an ingress node, according to various embodiments;

FIG. 9A is a first part of a flowchart diagram illustrating another method for telemetry setup at an ingress node, according to various embodiments;

FIG. 9B is a second part of the flowchart diagram of FIG. 9A; and

FIG. 10 is a diagram of a segment routing header, according to various embodiment.

### DETAILED DESCRIPTION

Reference throughout this specification to “one embodiment.” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including.” “comprising.” “having.” and variations thereof mean “including but not limited to” unless expressly specified otherwise. An enumerated listing of items does not imply that any or all of the items are mutually exclusive and/or mutually inclusive, unless expressly specified otherwise. The terms “a,” “an.” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components or may be implemented as an application-specific integrated circuit (“ASIC”). A module may also be implemented in programmable hardware devices such as a field programmable gate array (“FPGA”), programmable array logic, programmable logic devices or the like.

All or a portion of modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may include disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is non-transitory and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider). In some embodiments, electronic circuitry including, for example, programmable logic circuitry, field-programmable gate arrays (“FPGA”), or programmable logic arrays (“PLA”) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by hardware circuits, programmable hardware devices, and/or computer readable program instructions.

Where portions of a flowchart diagram are implement with computer readable program instructions, the computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

A telemetry processing apparatus for telemetry processing in a transit node or an egress node includes a tag reader module configured to read a tag of a tag field of a segment routing header of a data packet received at a node along a communication pathway. The communication pathway is described in a segment list in the segment routing header. The telemetry processing apparatus includes an attribute module configured to identify from the tag an attribute set with one or more in-band telemetry attributes to be collected from the node, and a telemetry write module configured to write the in-band telemetry attributes of the attribute set to a location of a current segment address of a segment list of the segment routing header. The current segment address corresponds to the node. At least a portion of the modules include hardware circuits, programmable hardware circuits and/or executable code where the executable code is stored on one or more non-transitory computer readable storage media.

In some embodiments, the telemetry processing apparatus includes a segment address module configured to, prior to the telemetry write module writing the in-band telemetry attributes to the location of the current segment address, extract a next segment address from the segment list of a next node in the communication pathway and to write the next segment address to a destination internet protocol (“IP”) address where the next segment address of the segment list corresponds to a segments left of a segments left field. In the embodiments, the telemetry processing apparatus includes a counter decrement module configured to decrement the segments left in the segment routing header in response to the telemetry write module writing the in-band telemetry attributes, and a packet processing module configured to, in response to the counter decrement module decrementing the segments left, forward the data packet to a next node corresponding to the next segment address in response to the segments left being greater than zero and to process the data packet in response to the segments left being zero.

In other embodiments, the telemetry processing apparatus includes a telemetry bypass module configured to bypass the telemetry write module writing the in-band telemetry attributes in response to the tag including a zero or a value not corresponding to an attribute set. In other embodiments, the tag in the tag field includes one of a plurality of tags for the communication pathway where each of the plurality of tags corresponds to an attribute set of in-band telemetry attributes to be collected from the node. The attribute sets corresponds to the plurality of tags is a total set of in-band telemetry data to be collected from the node. In other embodiments, a number of tags for the plurality of tags is determined based on a size of the total set of in-band telemetry data divided by a size of locations in the segment list. In other embodiments, an ingress node adds a first tag of the plurality of tags to a first packet in a flow of packets traversing the communication pathway and adds subsequent tags of the plurality of tags to subsequent packets in the communication pathway up to a last tag in the plurality of tags and the ingress node repeats adding tags in a same sequence to additional packet until a last packet of the flow of packets is sent by the ingress node.

In some embodiments, the attribute set is sized to fit in the location of the current segment address. In other embodiments, the in-band telemetry attributes of the attribute set include a hop latency, ingress queue occupancy, egress queue occupancy, Egress Interface Tx Utilization, buffer occupancy, ingress queue number, and/or egress queue number.

A telemetry setup apparatus for telemetry setup in an ingress node includes a telemetry receiver module configured to receive, at an ingress node, telemetry instructions from a network controller. The telemetry instructions include an attribute set with one or more in-band telemetry attributes to be collected from nodes along a communication pathway from the ingress node to an egress node by data packets of a source routing packet flow traversing the communication pathway. The telemetry setup apparatus includes a tag field module configured to write a tag to a tag field of a segment routing header of a data packet of the source routing packet flow where the tag corresponds to the attribute set, and a packet transmission module configured to transmit the data packet to a destination IP address of a next node in the communication pathway. The destination IP address corresponds to a segment address from a segment list in the segment routing header of the data packet. At least a portion of the modules include hardware circuits, programmable hardware circuits and/or executable code. The executable code is stored on one or more non-transitory computer readable storage media.

In some embodiments, the attribute set is a total attribute set and the total attribute set includes a plurality of in-band telemetry attributes with a size larger than a size of a location in the segment list. In the embodiments, the telemetry setup apparatus includes an attribute division module configured to divide the total attribute set into a plurality of attribute sets, a tag assignment module configured to assign a tag to each of the plurality of attribute sets, and/or an ingress telemetry module configured to write in-band telemetry attributes associated with the tag to a Type Length Value objects field of the segment routing header of the data packet.

In other embodiments, the telemetry setup apparatus includes a rolling tag module configured to write a tag corresponding to each of the plurality of attribute sets to the tag field of the segment routing header of subsequent data packets of the source routing packet flow in a rolling sequence prior to transmitting the data packets of the source routing packet flow to a next node. In other embodiments, the rolling tag module includes an in-band telemetry (“INT”) counter module configured to increment an INT counter in response to determining that the data packet is part of the source routing packet flow, and an INT limit module configured to determine if the INT counter is greater than or equal to an INT limit, the INT limit corresponding to a number of the plurality of attribute sets. In the embodiments, the tag field module is further configured to write a tag to the tag field of the segment routing header where the tag corresponds to the INT counter after incrementing by the INT counter module.

In other embodiments, the rolling tag module includes a new flow module configured to determine if the data packet is of a new source routing packet flow, and an INT counter reset module configured to reset the INT counter to zero in response to the new flow module determining that the data packet is of a new source routing packet flow and in response to the INT limit module determining that the INT counter is greater than or equal to the INT limit. In the embodiments, the tag field module is configured to write a tag to the tag field corresponding to an INT counter value of zero.

A telemetry processing method for in-band telemetry processing includes reading a tag of a tag field of a segment routing header of a data packet received at a node along a communication pathway. The communication pathway is described in a segment list in the segment routing header. The telemetry processing method includes identifying from the tag an attribute set comprising one or more in-band telemetry attributes to be collected from the node, and writing the in-band telemetry attributes of the attribute set to a location of a current segment address of a segment list of the segment routing header where the current segment address corresponds to the node.

In some embodiments, the telemetry processing method includes, prior to writing the in-band telemetry attributes to the location of the current segment address, extracting a next segment address from the segment list of a next node in the communication pathway and to writing the next segment address to a destination IP address, where the next segment address of the segment list corresponds to a segments left of a segments left field, decrementing the segments left in the segment routing header in response to writing the in-band telemetry attributes, and in response to decrementing the segments left, forwarding the data packet to a next node corresponding to the next segment address in response to the segments left being greater than zero and processing the data packet in response to the segments left being zero.

In other embodiments, the telemetry processing method includes bypassing writing the in-band telemetry attributes in response to the tag including a zero or a value not corresponding to an attribute set. In other embodiments, the tag in the tag field includes one of a plurality of tags for the communication pathway where each of the plurality of tags corresponds to an attribute set of in-band telemetry attributes to be collected from the node and where the attribute sets corresponding to the plurality of tags are a total set of in-band telemetry data to be collected from the node. In other embodiments, a number of tags for the plurality of tags is determined based on a size of the total set of in-band telemetry data divided by a size of locations in the segment list and/or an ingress node adds a first tag of the plurality of tags to a first packet in a flow of packets traversing the communication pathway, and adds subsequent tags of the plurality of tags to subsequent packets in the communication pathway up to a last tag in the plurality of tags and the ingress node repeats adding tags in a same sequence to additional packet until a last packet of the flow of packets is sent by the ingress node.

A telemetry setup method includes receiving, at an ingress node, telemetry instructions from a network controller. The telemetry instructions include an attribute set with one or more in-band telemetry attributes to be collected from nodes along a communication pathway from the ingress node to an egress node by data packets of a source routing packet flow traversing the communication pathway. The telemetry setup method includes writing a tag to a tag field of a segment routing header of a data packet of the source routing packet flow where the tag corresponds to the attribute set and transmitting the data packet to a destination IP address of a next node in the communication pathway. The destination IP address corresponds to a segment address from a segment list in the segment routing header of the data packet.

In some embodiments, the attribute set includes a total attribute set where the total attribute set includes a plurality of in-band telemetry attributes with a size larger than a size of a location in the segment list and the telemetry setup method includes dividing the total attribute set into a plurality of attribute sets, assigning a tag to each of the plurality of attribute sets, and/or writing in-band telemetry attributes associated with the tag to a Type Length Value objects field of the segment routing header of the data packet. In other embodiments, the telemetry setup method includes writing a tag corresponding to each of the plurality of attribute sets to the tag field of the source routing header of subsequent data packets of the source routing packet flow in a rolling sequence prior to transmitting the data packets of the source routing packet flow to a next node.

In other embodiments, the telemetry setup method includes incrementing an INT counter in response to determining that the data packet is part of the source routing packet flow, determining if the INT counter is greater than or equal to an INT limit, the INT limit corresponding to a number of the plurality of attribute sets, and/or writing a tag to the tag field of the segment routing header where the tag corresponds to the INT counter after incrementing. In other embodiments, the telemetry setup method includes determining if the data packet is of a new source routing packet flow, resetting the INT counter to zero in response to determining that the data packet is of a new source routing packet flow and in response to determining that the INT counter is greater than or equal to the INT limit, and writing a tag to the tag field corresponding to an INT counter value of zero.

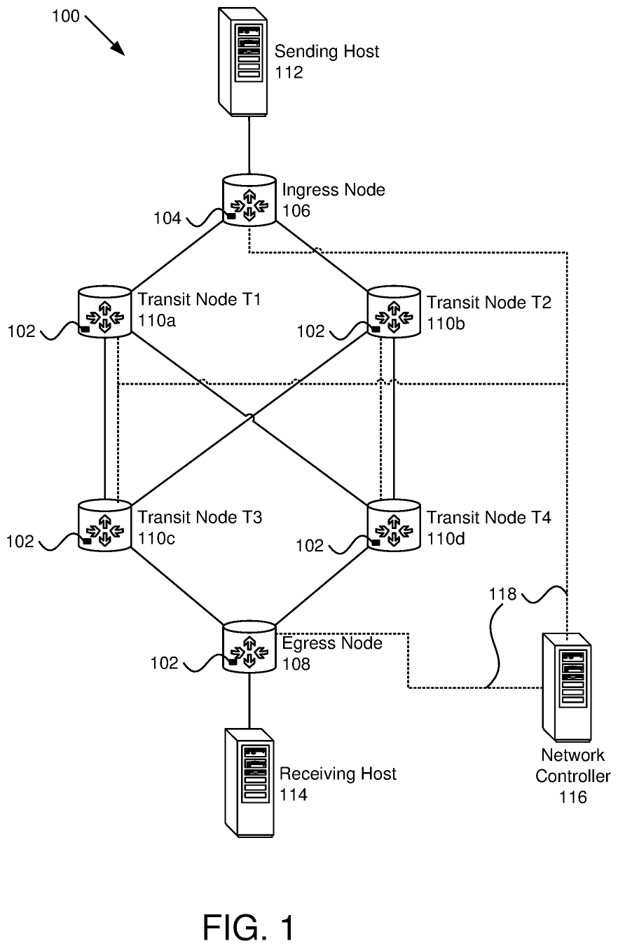

FIG. 1 is a schematic block diagram illustrating a system 100 for in-band telemetry, according to various embodiments. The system 100 includes telemetry processing apparatuses 102, a telemetry setup apparatus 104, an ingress node 106, an egress node 108, transit nodes 110a-110d (generically 110), a sending host 112, a receiving host 114, a network controller 116, and a management network 118, which are described below.

In the embodiments described herein, in-band refers to data flows, telemetry information, etc. that are controlled by the network controller 116 rather than external networks administered by various parties. For example, the sending host 112 and/or receiving host 114 may be part of multi-tenant servers with virtual machines each accessed by a client. In some embodiments, the sending host 112 and the receiving host 114 are computing devices configured for user access with a direct data connection to the ingress node 106 or egress node 108. In some embodiments, the system 100 includes a connection to one or more external networks, such as the Internet, a wide-area-network, a cellular network, and the like.

Typically, when a sending host 112 sends data to a receiving host 114, the data is divided into data packets where each data packet includes a header that includes where the data packet is coming from and where the data packet is going to. While the system 100 of FIG. 1 includes four transit nodes T1-T4 110a-110d, the embodiments described herein are applicable to other systems with different configurations and a different number of transit nodes connected in various ways. The sending host 112 may function to send data packets but may also function as a receiving host for data flows to the host identified as the sending host 112. As used herein, a data flow is a series of data packets of a single data structure that are being sent from a particular sending host 112 to a particular receiving host 114 where the data structure is a file, a command, an instruction, an image, etc. The data structure is divided into the data packets of a data flow. Other systems where the embodiments described herein include other hosts, which may also function as sending and/or receiving hosts. Other systems include other ingress nodes 106 and/or egress nodes 108, which may also serve a dual purpose as an ingress node and an egress node. One of skill in the art will recognize other systems where the in-band telemetry data embodiments described herein are applicable.

Some data packets include a 5-tuple in a header that includes a protocol, a source internet protocol (“IP”) address, a source port, a destination IP address, and a destination port. The protocol may be transmission control protocol (“TCP”) or user datagram protocol (“UDP”), but may be other protocols. The source IP address is the IP address of the ingress node 106. The destination IP address is the egress node 108, but may be a next node address in some routing schemes. The source and destination ports correspond to different services, such as Hypertext Transfer Protocol (“HTTP”), file transfer protocol (“FTP”), or the like.

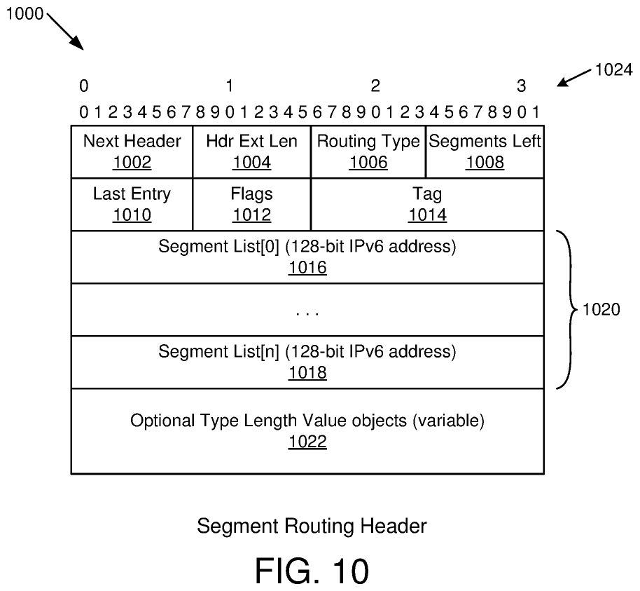

Some data packets allow an ingress node to access a routing table to identify a communication path between the ingress node 106 and the egress node 108. However, where the data packet includes a segment routing header, the file, data, instruction, etc. being transmitted use a source routing (“SR”) protocol, which may also be called path addressing. (SR may also refer to segment routing.) A definition of a segment routing header is depicted in FIG. 10, which is described in more detail below. Source routing allows a sender to partially or completely specify a route the data packet will take through a network. Source routing is advantageous when coupled with in-band telemetry where some nodes may be avoided due to latency issues.

A segment routing header (“SRH”) is typically used for the IP version 6 (“IPv6”) protocol, which has longer addresses than IP version 4 (“IPv4”). A segment routing header may also be used with other protocols now or in the future. A segment routing header includes a segment list with an IP address of each node in a communication pathway from the ingress node 106 to the egress node 108. Source routing specifies the exact path of data packets from the ingress node 106 to the egress node 108. For example, a communication pathway may go from the ingress node 106, to transit node T2 110b, to transit node T3 110c, to the egress node 108. For this particular data path, the segment list in the segment routing header includes an IP address (also referred to herein as a segment address) of the ingress node 106, transit node T2 110b, transit node T3 110c, and the egress node 108. As used herein, a segment routing header is any header now or in the future that includes a segment list of segment addresses along a specified route from an ingress node 106 to an egress node 108.

A feature of a data packet with a segment routing header is that once a segment address in the segment list is read and used to identify a next hop to a next node, the segment address in the segment list is no longer used. Embodiments described herein beneficially use this feature to store in-band telemetry data in segment address locations that have already been read and/or used, which provides a convenient way to include in-band telemetry data in a data packet without increasing the bandwidth of the communication pathway the data packet is traversing.

Other in-band telemetry systems often add in-band telemetry data at the expense of increasing the size of the data packet, which may reduce the bandwidth of the communication path of the data packets. Other in-band telemetry methods replicate data packets to create special telemetry packets, which also reduces bandwidth. Other in-band telemetry methods send a telemetry packet at a particular sampling rate, such as 1 telemetry packet for every 10,000 data packets, which may miss micro-bursts of data packets. The embodiments described herein provide in-band telemetry data collection without reducing bandwidth in a significant way.

The system 100 includes telemetry processing apparatuses 102 in transit nodes 110a-110d (or generically 110) and/or in an egress node 108. A telemetry processing apparatus 102 reads a tag of a tag field of a segment routing header of a data packet received at a transit node 110 or egress node 108. The telemetry processing apparatuses 102 identifies from the tag and attribute set of in-band telemetry data to be collected from the node that received the data packet and then writes the in-band telemetry attributes of the attribute set to a current segment address of the segment list of the source routing header of the data packet before transmitting the data packet to the next node in the segment list.

In some embodiments, a location of a segment address is 128 bits. Other locations of segment addresses in segment lists in other segment routing headers may be larger or smaller. Where the attributes to be collected are too big to fit in a location of a segment header, a total attribute set specified by the network controller 116 or other device splits the total attribute set into multiple attribute sets, each corresponding to a tag. The telemetry setup apparatus 104 in the ingress node 106 then includes the different tags in a rolling sequence in data packets. For example, if there are three attribute sets for a particular data flow, the telemetry setup apparatus 104 includes a first tag with a first data packet, a second tag with a second data packet, and a third tag with a third data packet. When the fourth data packet is received, the telemetry setup apparatus 104 starts over and includes the first tag. A fifth data packet gets the second tag, and so forth. Thus, all of the specified attributes are collected every three data packets.

Where there are multiple attribute sets and corresponding tags in a data flow, the telemetry processing apparatuses 102 write appropriate in-band telemetry data for a particular tag to the location of the current segment address. For example, tag 1 may correlate to collection of attributes A and B, tag 2 may correlate to collection of attributes C and D, and tag 3 may correlate to collection of attribute E. The telemetry processing apparatus 102 writes whatever in-band telemetry attributes are appropriate for the tag in the tag field of the current data packet.

At each network node 106, 110, 108, telemetry attributes are collected and written to a current segment address. A telemetry attribute is any parameter added to a telemetry header by a network node 106, 110, 108. Typical network nodes 106, 110, 108, such as routers, switches, etc. keep track of various parameters useful in tracking operation of the network node 106, 110, 108. Typically, one or more timestamps are added to a header and/or telemetry header, which is useful in determining latency. A typical telemetry attribute is hop latency, which in some embodiments is a measure of how long the network node 106, 110, 108 takes to transmit a received a data packet and/or a telemetry packet to a next network node 106, 110, 108. One of skill in the art will recognize various ways to determine hop latency.

Another telemetry attribute that is useful in determining performance of a network node 106, 110, 108 is queue occupancy, such as ingress queue occupancy or egress queue occupancy. Typically, a queue identifier (“ID”) is recorded along with a number of data/telemetry packets in the queue. In some embodiments, the queue ID and queue occupancy are recorded for more than one queue in the network node 106, 110, 108. Another often used telemetry attribute is Egress Interface Tx Utilization, which is a measure of how many data/telemetry packets are being transmitted in a particular amount of time, such as packets per second.

Another telemetry attribute that is useful in determining performance of a network node 106, 110, 108 is buffer occupancy. Typically, data packets and telemetry packets are stored in memory after they are received at an ingress port of a network node 106, 110, 108. The memory of the network node 106, 110, 108 is often divided into buffers, such as a multicast buffer for multicast data packets, a unicast buffer for unicast data packets, and the like. Queues typically include an address of a data/telemetry packet in a queue entry rather than the actual data/telemetry packet. Typically, a buffer ID is recorded along with an amount of data/telemetry packets in the buffer as buffer occupancy. In some embodiments, the buffer ID and buffer occupancy are recorded for more than one buffer in the network node 106, 110, 108. One of skill in the art will recognize other telemetry attributes tracked by a network node 106, 110, 108.

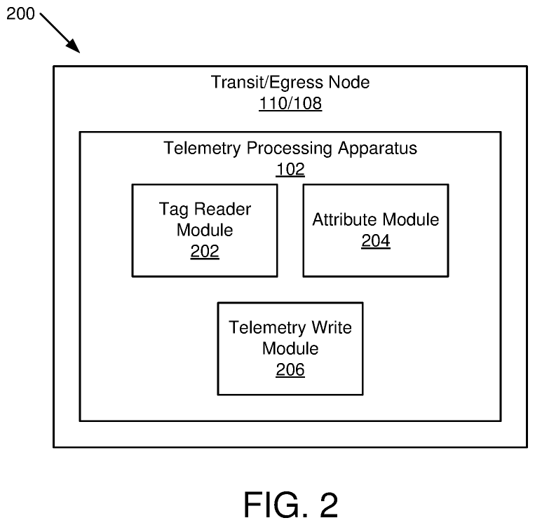

At the egress node 108, the telemetry data in the segment list is read and transmitted to the network controller 116 or other device over the management network 118. In addition, typically the segment routing header is stripped from the data packet and the data packet is transmitted to the receiving host 114, as is typical for data transmission systems. The telemetry processing apparatus 102 and the telemetry setup apparatus 104 are described in more detail with regard to the apparatuses 200, 300, 400, 500 of FIGS. 2-5.

The system 100 includes an ingress node 106, which typically has more functionality than a transit node 110. The ingress node 106 receives a data packet from the sending host 112. The sending host 112 includes with the data packet which receiving host 114 is to receive the data packet. The sending host 112 or the ingress node 106 will specify which nodes are to be included in the segment list where a data packet from the sending host 112 is using the source routing protocol.

The system 100 includes transit nodes 110. Typically, a transit node 110 is limited to transmitting a data packet for a source routing protocol data packet. However, in some embodiments a transit node 110 may be acting as a transit node 110 for one data flow and may be acting as an ingress node 106 or egress node 108 for other data flows.

The system 100 includes an egress node 108, which may be an egress node 108 for a particular data flow. In some embodiments, the egress node 108 may also function as an ingress node 106 or as a transit node 110 for other data flows. The egress node 108 includes functionality to process a data packet before forwarding the data packet to the receiving host 114. The egress node 108 also transmits the in-band telemetry data stored in the segment list of the segment routing header to the network controller 116 or other device, such as to the ingress node 106. In some embodiments, the ingress node 106 is capable to reacting to in-band telemetry data to either change which nodes are traversed in a data flow or to inform another device of network issued identified in the in-band telemetry data so the other device can alter the data flow.

Typically, the ingress node 106, the transit nodes 110, and the egress node 108 are all routers. In some embodiments, the routers include varying functionality depending on factors such as whether or not the node will function as an ingress node, and egress node, a transit node, or a combination thereof. In other embodiments, the ingress node 106, the transit nodes 110, and the egress node 108 are not routers but are different devices capable of preparing, transmitting and/or processing data packets as well as supporting the telemetry processing apparatus 102 and/or the telemetry setup apparatus 104. Often the ingress node 106, the transit nodes 110, and the egress node 108 are specialty devices capable of transmitting data at high bandwidths and are not general purpose computers. The apparatuses 102, 104 described herein are also configured to process data packets at a high rate and often include hardware circuits. One of skill in the art will recognize other devices and configurations of nodes of the system 100.

The system 100 includes a sending host 112 and a receiving host 114. The sending and receiving hosts 112, 114, in some embodiments, are gateway devices of one or more private networks, such as networks that include other computers, printers, hubs, switches, etc. In other embodiments, the sending host 112 and/or the receiving host 114 are endpoint computing devices that are not part of another private network. In various embodiments, the sending and receiving hosts 112, 114 may be desktop computers, rack-mounted servers, workstations, smart phones, tablet computers, printers, or other computing devices. One of skill in the art will recognize other devices that serve as a sending host 112 and/or a receiving host 114 using a source routing protocol.

The system 100 is depicted with a network controller 116 connected to the nodes 106, 108, 110 over a separate network 118, which may be a management network 118. In other embodiments, the network controller 116 communicates with the nodes 106, 108, 110 over a same network as data packets traverse. In some embodiments, the system 100 includes one or more additional network controllers 116 or other computing device capable of communicating with the nodes 106, 108, 110 and at least specifying which attributes will be collected during in-band telemetry.

The nodes 106, 108, 110 of the system 100 communicate using a computer network, which may include a LAN, a WAN, a fiber network, a wireless connection or a combination thereof. The computer network may include multiple private and/or public networks. The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (“ASTM”®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

FIG. 2 is a schematic block diagram illustrating an apparatus 200 for telemetry processing in a transit node 110 or an egress node 108, according to various embodiments. The apparatus 200 includes a telemetry processing apparatus 102, which could be in a transit node 110 or an egress node 108, with a tag reader module 202, an attribute module 204, and a telemetry write module 206, which are described below. In some embodiments, all or a portion of the apparatus 200 is implemented using hardware circuits, such as an ASIC. In other embodiments, all or a portion of the apparatus 200 is implemented using a programmable hardware device. All or a portion of the apparatus 200 may also be implemented using executable code stored on a non-transitory computer readable storage device.

The apparatus 200 includes a tag reader module 202 configured to read a tag of a tag field of a segment routing header of a data packet received at a node, such as a transit node 110 or an egress node 108, along a communication pathway. The communication pathway is described in a segment list in the segment routing header. The tag field 1014 is depicted in the segment routing header 1000 of FIG. 10.

The segment routing header 1000 of FIG. 10 is one possible segment routing header with a segment list and is in a document by the Internet Engineering Task Force (“IETF”), Request for Comments (“RFC”) 8754 published March 2020. The segment routing header includes the following fields:
Next Header 1002—Identifies the type of header immediately following the segment routing header.
Hdr Ext Len 1004—Length of the routing header in 8-octet units, not including the first 8 octets.
Routing Type 1006—Has a value of 4.
Segments Left 1008—Number of route segments remaining, i.e., number of explicitly listed intermediate nodes still to be visited before reaching the final destination.
Last entry 1010—Contains the index (zero based), in the Segment List, of the last element of the Segment List.
Flags 1012—8 bits of flags. Various flags have been registered with many flag values undefined.
Tag 1014—A data packet as part of a class or group of data packets, e.g., data packets sharing the same set of properties. Set to zero when not used. Tag 1014 is uses herein as a designation of which attribute set of in-band telemetry attributes are to be collected and written to a current segment address.
Segment List [0] 1016 is a first segment address in the segment list 1120. In the embodiment of the segment routing header 1000 of FIG. 10, each segment address has a size of 128 bits.
Segment List [n] 1018 is a n^{th} and final segment address in the segment list 1120.
Optional Type Length Value (“TLV”) objects 1122-A TLV provides metadata for segment processing and is optional and known to those of skill in the art. In some embodiments, the TLV objects field 122 is used to store in-band telemetry attributes for the ingress node 106.

The numbers 1024 at the top of the segment routing header 1000 indicate bit numbers. In some embodiments, in-band telemetry data to be collected fits in one segment address location, e.g., has a size of 128 bits or less, so that all tags 1014 in a data flow have the same tag 1014. For example, the in-band telemetry data is limited to latency so the tag 1014 in the segment routing header 1000 of all data packets in a data flow are all the same tag 1014. In another embodiment, the total attribute segments to be collected will not fit into a single segment address location and are broken up into attribute sets. Each of the attribute sets are assigned a tag 1014. Each tag 1014 is interpreted by the attribute module 204 or other portion of the telemetry processing apparatus 102 to identify which in-band telemetry attributes are to be collected for the data packet containing the tag 1014. For example, there may be three attribute sets for a data flow where each attribute set is correlated to one of three tags 1014. Each of the three tags 1014 collects different in-band telemetry attributes. Every three data packets in the data flow collects all of the in-band telemetry attributes the total attribute sets to be collected.

The apparatus 200 includes an attribute module 204 configured to identify from the tag 1014 an attribute set with one or more in-band telemetry attributes to be collected from the node (transit node 110 or egress node 108). Each tag 1014 is associated with different in-band telemetry attributes. In some embodiments, the attribute module 204 accesses a table or similar data structure with tags 1014 and in-band telemetry attributes to identify from the tag 1014 of the data packet which in-band telemetry attributes to collect. In some embodiments, the attribute module 204 receives tags 1014 and associated in-band telemetry attributes. In other embodiments, attribute module 204 includes a table or other data structure with tags 1014 and associated in-band telemetry attributes. One of skill in the art will recognize other ways for the attribute module 204 to identify in-band telemetry attributes to collect from the tag 1014 in the segment routing header 1000 of the data packet.

The apparatus 200 includes a telemetry write module 206 configured to write the in-band telemetry attributes of the attribute set to a location of a current segment address of a segment list 1020 of the segment routing header 1000. The current segment address corresponds to the node (transit node 110 or egress node 108) processing the data packet with the segment routing header 1000 with the tag 1014 read by the tag reader module 202. For example, if the data packet is received at transit node T2 110b, which is a first hop after the ingress node 106, the telemetry write module 206 writes the in-band telemetry attributes to the first segment address (e.g., segment list [0] 1016) of the segment list 1020. Since the data packet is already at the transit node T2 110b corresponding to first entry (segment list [0] 1016) of the segment list 1020 and this first entry is no longer needed and can be replaced by in-band telemetry data. The data packet is then transmitted to the next node in the segment list 1020.

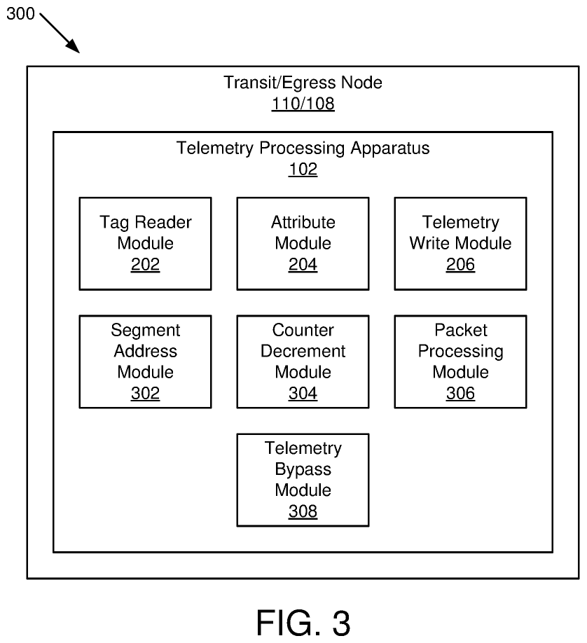

FIG. 3 is a schematic block diagram illustrating another apparatus 300 for telemetry processing in a transit node 110 or an egress node 108, according to various embodiments. The apparatus 300 includes another a telemetry processing apparatus 102, which could be in a transit node 110 or an egress node 108, with a tag reader module 202, an attribute module 204, and a telemetry write module 206, which are substantially similar to those described above in relation to the apparatus 200 of FIG. 2. The apparatus 300 includes, in various embodiments, a segment address module 302, a counter decrement module 304, a packet processing module 306, and/or a telemetry bypass module 308, which are described below. The apparatus 300 may be implemented similar to the apparatus 200 of FIG. 2.

The apparatus 300, in some embodiments, includes a segment address module 302 configured to, prior to the telemetry write module 206 writing the in-band telemetry attributes to the location of the current segment address, extract a next segment address from the segment list 1020 of a next node in the communication pathway and to write the next segment address to a destination internet protocol (“IP”) address. In some embodiments, the destination IP address is in a 5-tuple header that includes a protocol, a source IP address, a source port, the destination IP address, and a destination port, as discussed above.

The next segment address of the segment list 1020 corresponds to a current value of a segments left 1008. The segments left 1008, in some embodiments, starts at a value equal to the number of hops in the communication pathway of the data flow from the ingress node 106 to the egress node 108. For example, where the data flow is from the ingress node 108, to transit node T2 110b, to transit node T3 110c, to the egress node 108, there are three hops so the segments left 1008 starts at three.

The apparatus 300, in some embodiments, includes a counter decrement module 304 configured to decrement the segments left 1008 in the segment routing header 1000 in response to the telemetry write module 206 writing the in-band telemetry attributes. The value of the segments left 1008 is used as a pointer with respect to the segment list 1020 to point to an appropriate segment address in the segment list 1020. In other alternate embodiments, the segments left 1008 includes the total number of nodes in the data flow (e.g., one more than the number of hops) and the counter decrement module 304 decrements the segments left 1008 before the segment address module 302 writes the current segment address to the destination IP address. In these embodiments, the value of the segments left 1008 will have a higher value at the egress node 108 than where the counter decrement module 304 decrements the segments left 1008 after the segment address module 302 writes the next segment address to the destination IP address. Action of the counter decrement module 304 and the segment address module 302 are coordinated to properly account for the order in which the segment address module 302 and the counter decrement module 304 operate.

The apparatus 300, in some embodiments, includes a packet processing module 306 configured to, in response to the counter decrement module 304 decrementing the segments left 1008, forward the data packet to a next node corresponding to the next segment address in response to the segments left 1008 being greater than zero and to process the data packet in response to the segments left 1008 being zero. In the embodiments, where the segments left 1008 is zero, the data packet should be at the egress node 108. Processing the data packet at the egress node 108 includes stripping off the segment routing header 1000 and/or other layer 4 IP header and transmitting the data packet to the receiving host 114. Processing the data packet at the egress node 108 also includes reading the in-band telemetry attributes from the segment list 1020 and transmitting the in-band telemetry attributes to the network controller 116 or other device.

Where the counter decrement module 304 operates before the segment address module 302, the value of the segments left 1008 will be one instead of zero and the packet processing module 306 processes the data packet at the egress node 108 in response to the segments left 1008 being one. In other embodiments, the packet processing module 306 performs other functions associated with packet processing at the transit nodes 110 and/or egress node 108.

In some embodiments, the apparatus 300 includes a telemetry bypass module 308 configured to bypass the telemetry write module 206 writing the in-band telemetry attributes in response to the tag 1014 being a zero or a value not corresponding to an attribute set. The telemetry bypass module 308, in some embodiments, operates to avoid collecting in-band telemetry data for data packets that have a tag 1014 not associated with in-band telemetry data collection. Where the tag 1014 is zero, which is a default value, the data packet does not collect in-band telemetry data and may not be of some other data flow that uses tags 1014. Tags 1014 may be used for another purpose other than in-band telemetry data collection and where a tag 1014 does not correspond to an attribute set, the telemetry bypass module 308 bypasses the telemetry write module 206 writing in-band telemetry data to an entry (e.g., 1016, 1018) of the segment list 1020.

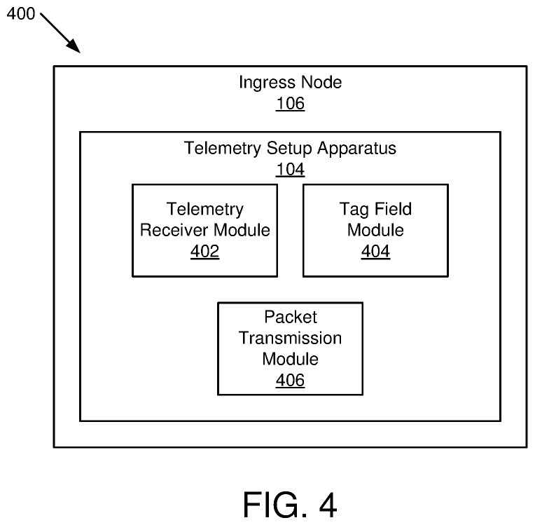

FIG. 4 is a schematic block diagram illustrating an apparatus 400 for telemetry setup in an ingress node 106, according to various embodiments. The apparatus 400 includes a telemetry setup apparatus 104, in the ingress node 106, with a telemetry receiver module 402, a tag field module 404, and a packet transmission module 406, which are described below. In some embodiments, all or a portion of the apparatus 400 is implemented using hardware circuits, such as an ASIC. In other embodiments, all or a portion of the apparatus 400 is implemented using a programmable hardware device. A portion of the apparatus 400 may also be implemented using executable code stored on a non-transitory computer readable storage device. While the telemetry setup apparatus 104 is depicted in the ingress node 106, a portion of the telemetry setup apparatus 104 may be located elsewhere, such as in the network controller 116. For example, the tag field module 404 may be in the network controller 116 where tags 1014 are pre-assigned to in-band telemetry attributes.

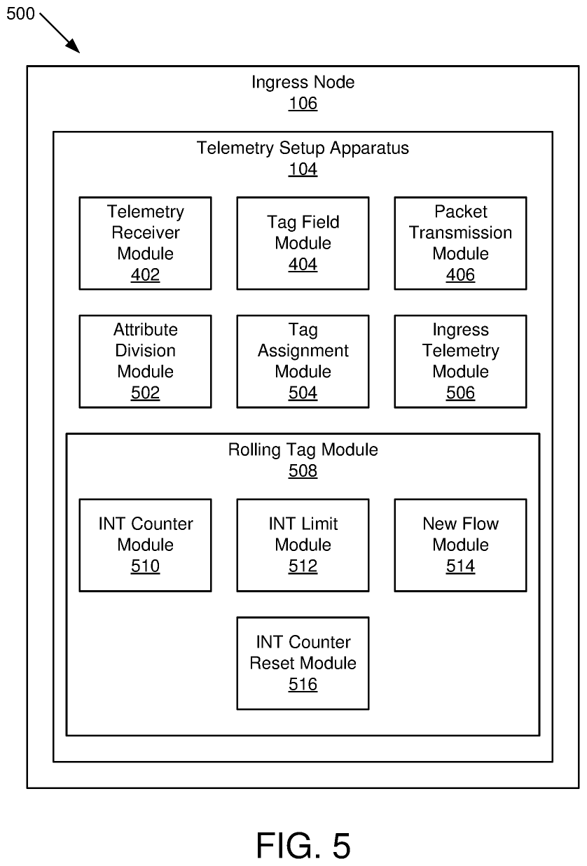

The apparatus 400 includes a telemetry receiver module 402 configured to receive, at an ingress node 106, telemetry instructions from a network controller 116 or other device authorized to request in-band telemetry data. The telemetry instructions include an attribute set with one or more in-band telemetry attributes to be collected from nodes along a communication pathway from the ingress node to an egress node by data packets of a source routing packet flow traversing the communication pathway. In some embodiments, the attribute set from the telemetry instructions are sized to fit within a location of a segment address in the segment list 1020 of a segment routing header 1000 of a data packet. In other embodiments, the attribute set from the telemetry instructions are not sized to fit within a location of a segment address, which is discussed below with respect to the apparatus 500 of FIG. 5.

The apparatus 400 includes a tag field module 404 configured to write a tag 1014 to a tag field of a segment routing header 1000 of a data packet of the source routing packet flow. The tag 1014 corresponding to the attribute set such that an attribute module 204 of a transit node 110 or egress node 108 is able to identify which in-band telemetry attributes are to be collected at the node where the data packet is being processed. In some examples, the ingress node 106 includes a list of tags 1014 and corresponding in-band telemetry attributes and selects and appropriate tag 1014. In other embodiments, the tag field module 404 accesses a table or other data structure to retrieve an appropriate tag 1014 for the attributes in the telemetry instructions. In other embodiments, one or more tags 1014 are received with the telemetry instructions. One of skill in the art will recognize other ways for the tag field module 404 to determine which tag 1014 is to be stored in the segment routing header 1000.

The apparatus 400 includes a packet transmission module 406 configured to transmit the data packet to a destination IP address of a next node (e.g., transit node 110 or egress node 108) in the communication pathway. The destination IP address corresponds to a segment address from a segment list 1020 in the segment routing header 1000 of the data packet. In some embodiments, the packet transmission module 406 coordinates with the ingress node 106 for other processing of the data packet prior to transmission and/or for transmitting the data packet. In some embodiments, the packet transmission module 406 transmits the data packet by signaling the ingress node 106 to transmit the data packet, for example, in response to the tag field module 404 writing a tag 1014 to the segment routing header 1000.

FIG. 5 is a schematic block diagram illustrating another apparatus 500 for telemetry setup in an ingress node 106, according to various embodiments. The apparatus 500 includes a telemetry setup apparatus 104, in the ingress node 106, with a telemetry receiver module 402, a tag field module 404, and a packet transmission module 406, which are substantially similar to those described above in relation to the apparatus 400 of FIG. 4. The apparatus 500, in various embodiments, includes an attribute division module 502, a tag assignment module 504, an ingress telemetry module 506, and/or a rolling tag module 508 which includes an in-band telemetry (“INT”) counter module 510, an INT limit module 512, a new flow module 514, and/or an INT counter reset module 516, which are described below. In various embodiments, all or a portion of the apparatus 500 is implemented similar to the apparatus 400 of FIG. 4.

The apparatus 500 includes an attribute division module 502 and/or a tag assignment module 504. As mentioned above, in some embodiments the attribute set from the telemetry instructions is a total attribute set that includes a plurality of in-band telemetry attributes with a size larger than a size of a location in the segment list 1020. In this situation, the total attribute set needs to be split into attribute sets that will each fit in a location of a segment address in the segment list 1020. The attribute division module 502 is configured to divide the total attribute set into a plurality of attribute set. In some embodiments, each of the attribute sets are sized to fit in a location of a segment address in the segment routing header 1000. In some embodiments, the attribute division module 502 sets an INT limit based on the number of attribute sets. For example, if the attribute division module 502 creates three attribute sets, the attribute division module 502 also sets an INT limit to be three. The INT limit is discussed in more detail below.

In some embodiments, the apparatus 500 includes a tag assignment module 504 configured to assign a tag 1014 to each of the plurality of attribute sets. In some embodiments, the tag assignment module 504 assigns tags 1014 to attribute sets prior to the telemetry receiver module 402 receiving telemetry instructions. In some examples, the tag assignment module 504 creates or is used, by a user, to create an association between tags 1014 and attribute sets by way of a table or similar data structure and the tag assignment module 504, network controller 116 or other device sends the table or data structure to the ingress node 106, transit nodes 110, and egress node 108.

In some embodiments, the apparatus 500 includes an ingress telemetry module 506 configured to write in-band telemetry attributes associated with the tag 1014 to a Type Length Value objects field 1022 of the segment routing header 1000 of the data packet. In some examples where in-band telemetry data is requested for all nodes including the ingress node 106, the ingress telemetry module 506 collects in-band telemetry data from the ingress node 106 that matches the attribute set associated with the tag 1014. The ingress telemetry module 506 writes the in-band telemetry attributes of the ingress node 106 to the Type Length Value objects field 1022 in cases where there is no segment location for the ingress node 106 in the segment list 1020. In other embodiments, the apparatus 500 does not include the ingress telemetry module 506 or the ingress telemetry module 506 is not functional.

The apparatus 500 includes, in some embodiments, a rolling tag module 508 configured to write a tag 1014 corresponding to each of the plurality of attribute sets to the tag field of the segment routing header 1000 of subsequent data packets of the source routing packet flow in a rolling sequence prior to transmitting the data packets of the source routing packet flow to a next node. For example, where the attribute division module 502 divides the total attribute set into three attribute sets, each attribute set is associated with a tag 1014. The rolling tag module 508 would write a first tag 1014 associated with a first attribute set to a first data packet prior transmission of the first data packet to a next node, the rolling tag module 508 would write a second tag 1014 associated with a second attribute set to a second data packet prior to transmission of the second data packet to the next node, and the rolling tag module 508 would write a third tag 1014 associated with a third attribute set to a third data packet prior to transmission of the third data packet to the next node.

For a fourth data packet, the rolling tag module 508 would start over and write the first tag 1014 to the fourth data packet prior to transmission of the fourth data packet. The rolling tag module 508 would continue this pattern so that every three data packets of the source routing data flow would include the total attribute set.

In some embodiments, the rolling tag module 508 includes an INT counter module 510, an INT limit module 512, a new flow module 514, and/or an INT counter reset module 516. In the embodiments, the INT counter module 510 is configured to increment an INT counter in response to determining that the data packet is part of the source routing packet flow and the INT limit module 512 is configured to determine if the INT counter is greater than or equal to an INT limit. The INT limit corresponds to a number of the plurality of attribute sets. For example, if there are three attribute sets then the INT limit is three. The tag field module 404 is further configured to write a tag 1014 to the tag field of the segment routing header 1000 where the tag 1014 corresponds to the INT counter after incrementing by the INT counter module 510.

For example, if the INT counter starts at zero, which would be indicative of the INT counter being initialized to zero for a new packet flow or after reaching the INT limit, the INT counter module 510 then increments the INT counter to one and the tag field module 404 writes a tag 1014 to the segment routing header 1000 corresponding to the INT counter being one. The tag 1014 corresponds to a first attribute set. If the INT counter is one and the INT counter module 510 increments the INT counter to two, the tag field module 404 writes a second tag 1014 to the segment routing header 1000 that corresponds to the INT counter being two and also corresponds to a second attribute set.

The new flow module 514 is configured to determine if the data packet is of a new source routing packet flow and the INT counter reset module 516 is configured to reset the INT counter to zero in response to the new flow module 514 determining that the data packet is of a new source routing packet flow. In addition, the INT counter reset module 516 is configured to reset the INT counter to zero in response to the INT limit module 512 determining that the INT counter is greater than or equal to the INT limit. Thus, the INT counter reset module 516 starts the INT counter over after reaching the INT limit or if there is a new data flow. Note that the INT counter module 510, the INT limit module 512, the new flow module 514, and the INT counter reset module 516 are one particular implementation of the rolling tag module 508 and one of skill in the art will recognize other ways for the rolling tag module 508 to rotate tags 1014 through a sequence where there are more than one attribute set divided from a total attribute set.

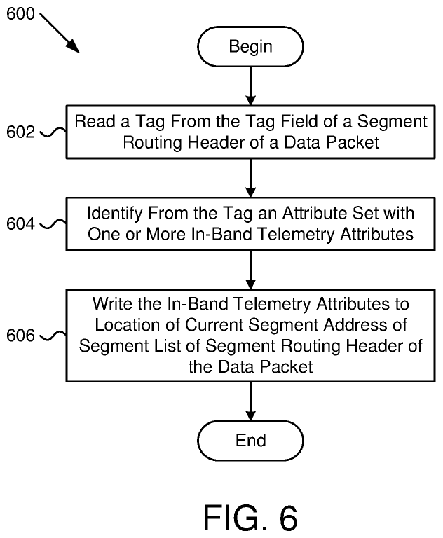

FIG. 6 is a flowchart diagram illustrating a method 600 for telemetry processing at a transit node 110 or an egress node 108, according to various embodiments. The method 600 begins and reads 602 a tag 1014 of a tag field of a segment routing header 1000 of a data packet received at a node (e.g., transit node 110, egress node 108) along a communication pathway. The communication pathway is described in a segment list 1020 in the segment routing header 1000. The method 600 identifies 604 from the tag 1014 an attribute set with one or more in-band telemetry attributes to be collected from the node and writes 606 the in-band telemetry attributes of the attribute set to a location of a current segment address of a segment list 1020 of the segment routing header 1000 where the current segment address corresponds to the node, and the method 600 ends. In various embodiments, some or all of the method 600 is implemented using the tag reader module 202, the attribute module 204, and/or the telemetry write module 206.

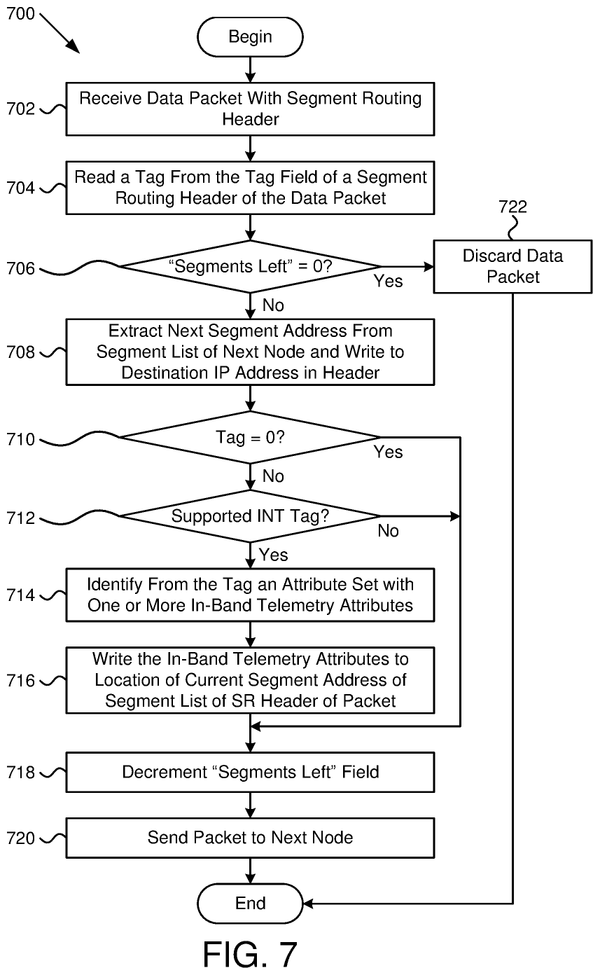

FIG. 7 is a flowchart diagram illustrating another method 700 for telemetry processing at a transit node 110 or an egress node 108, according to various embodiments. The method 700 begins and receives 702 a data packet with a segment routing header 1000 and reads 704 a tag 1014 of a tag field of a segment routing header 1000 of a data packet received at a node (e.g., transit node 110 or egress node 108) along a communication pathway where the communication pathway is described in a segment list 1020 in the segment routing header 1000. The method 700 determines 706 whether a segments left field 1008 of the segment routing header 1000 is zero.

If the method 700 determines 706 that the segments left field 1008 is not zero, the method 700 extracts 708 a next segment address from the segment list 1020 and writes the next segment address to a destination IP address in a header for the data packet. The segments left field 1008 is a pointer to the next segment address in the segment list 1020 and the method 700 reads the segments left field 1008 to determine the next segment address to write to the destination IP address. The method 700 determines 710 if the tag 1014 is zero. If the method 700 determines 710 that the tag 1014 is not zero, the method 700 determines 712 if the tag 1014 is a supported in-band telemetry tag.

If the method 700 determines 712 that the tag 1014 is a supported in-band telemetry tag, the method 700 identifies 714 from the tag 1014 an attribute set with one or more in-band telemetry attributes to be collected from the node and writes 716 the in-band telemetry attributes of the attribute set to a location of a current segment address of a segment list 1020 of the segment routing header 1000 where the current segment address corresponding to the node. For example, if the current segment address is for transit node T2 110b, which is a first segment address (e.g., 1016) in the segment list 1020, the method 700 writes 716 the in-band telemetry attributes of the attribute set to the first segment address 1016 in the segment list 1020.

The method 700 decrements the segments left 1008 in the segment routing header 1000 and sends 720 the data packet to the next node, and the method 700 ends. If the method 700 determines 710 that the tag 1014 is zero or determines 712 that the tag 1014 is not a supported in-band telemetry tag, the method 700 decrements 718 the segments left field 1008 without identifying the tag 1014 or writing in-band telemetry attributes to the location of the current segment address. If the method 700 determines 706 that the segments left field 1008 is zero, signifying an error or other problem, the method 700 discards 722 the data packet, and the method 700 ends. In various embodiments, some or all of the method 700 is implemented using the tag reader module 202, the attribute module 204, the telemetry write module 206, the segment address module 302, the counter decrement module 304, the packet processing module 306, and/or the telemetry bypass module 308.

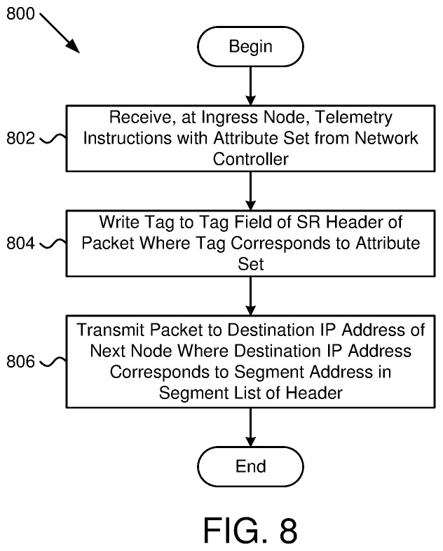

FIG. 8 is a flowchart diagram illustrating a method 800 for telemetry setup at an ingress node 1008, according to various embodiments. The method 800 begins and receives 802, at the ingress node 106, telemetry instructions from a network controller 116 or other device. The telemetry instructions include an attribute set with one or more in-band telemetry attributes to be collected from nodes along a communication pathway from the ingress node 106 to an egress node 108 by data packets of a source routing packet flow traversing the communication pathway. The method 800 writes 804 a tag 1014 to a tag field of a segment routing header 1000 of a data packet of the source routing packet flow where the tag 1014 corresponds to the attribute set. The method 800 transmits 806 the data packet to a destination IP address of a next node (e.g., transit node T2 110b) in the communication pathway, and the method 800 ends. The destination IP address corresponds to a segment address (e.g., IP address of transit node T2 110b) from a segment list 1020 in the segment routing header 1000 of the data packet. In various embodiments, some or all of the method 800 is implemented using the telemetry receiver module 402, the tag field module 404, and/or the packet transmission module 406.

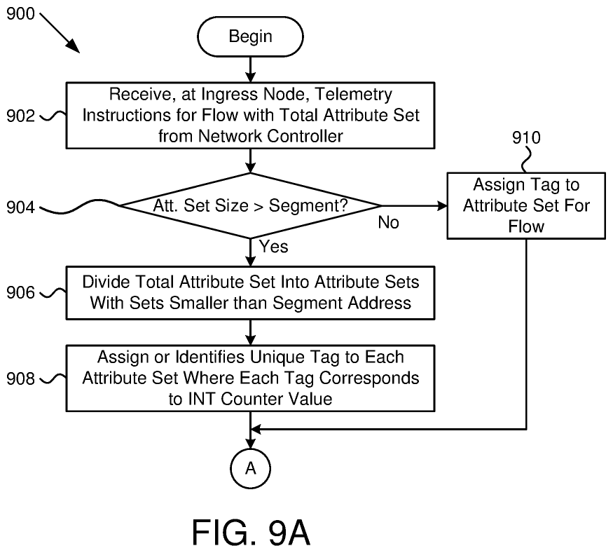

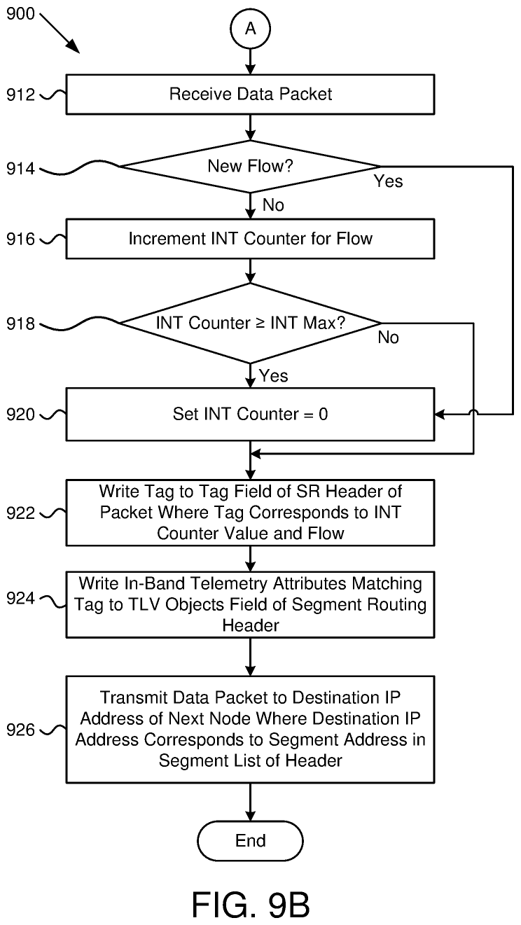

FIG. 9A is a first part and FIG. 9B is a second part of a flowchart diagram illustrating another method 900 for telemetry setup at an ingress node 106, according to various embodiments. The method 900 begins and receives 902, at the ingress node 106, telemetry instructions from a network controller 116 or other controlling device. The telemetry instructions include an attribute set with one or more in-band telemetry attributes to be collected from nodes along a communication pathway from the ingress node 106 to the egress node 108 by data packets of a source routing packet flow traversing the communication pathway.

The method 900 determines 904 if a total attribute set received in the telemetry instructions has a size greater than a size of a location of a segment address in the segment routing header 1000 of a source routing data packet. If the method 900 determines 904 that the size of the total attribute set is greater than the size of a segment address, the method 900 divides 906 the total attribute set into a plurality of attribute sets and assigns 908 or identifies a unique tag 1014 for each attribute set. Each tag 1014 corresponds to an INT counter value. If the method 900 determines 904 that the size of the total attribute set is not greater than the size of a segment address, the method 900 assigns 910 one tag 1014 to the attribute set for the data flow.

Follow “A” on FIG. 9A to “A” on FIG. 9B and the method 900 receives 912 a data packet and determines 914 if the data packet is from a new data flow. The method 900 determines 914 if the data packet is from a new data flow typically by reading a 5-tuple and other data in a header of the data packet to determine if the items in the 5-tuple and header match a 5-tuple and a header of data packets from an existing data flow. If the method determines 914 that the data packet is not from a new data flow, the method 900 increments 916 an INT counter belonging to the data flow and determines 918 if the INT counter is greater than or equal to an INT max for the data flow. The INT max matches a number of attribute sets for the data flow after the method 900 divided 906 the total attribute set.

If the method 900 determines 918 that the INT counter is greater than or equal to the INT max, the method 900 sets 920 the INT counter to zero and writes 922 a tag 1014 to a tag field of a segment routing header 1000 of the data packet of the source routing packet flow where the tag 1014 corresponding to the INT counter value of zero, which would be the first attribute set. If the method 900 determines 918 that the INT counter is less than the INT max for the data flow, the method 900 writes 922 a tag 1014 to the tag field of the segment routing header 1000 corresponding to the INT counter value. For example, if the INT counter is one, the method 900 writes a tag 1014 corresponding to a second attribute set to the segment routing header 1000. If the method 900 determines 914 that the received data packet is from a new data flow, the method 900 sets 920 the INT counter to zero before writing 922 an appropriate tag 1014 for the new data flow to the segment routing header 1000 of the data packet.

In some embodiments where in-band telemetry data is collected at the ingress node 106, the method 900 writes 924 in-band telemetry attributes associated with the tag to a Type Length Value (“TLV”) objects field 1022 of the segment routing header 1000 of the data packet. The method 900 transmits 926 the data packet to the destination IP address of the next node. The destination IP address corresponds to a first segment address (e.g., 1016) of the segment list 1020 of the segment routing header 1000, and the method 900 ends. In various embodiments, some or all of the method 800 is implemented using the telemetry receiver module 402, the tag field module 404, the packet transmission module 406, the attribute division module 502, the tag assignment module 504, the ingress telemetry module 506, and/or the rolling tag module 508, which may include the INT counter module 510, the INT limit module 512, the new flow module 514, and/or the INT counter reset module 516.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a tag reader module configured to read a tag of a tag field of a segment routing header of a data packet received at a node along a communication pathway, the communication pathway described in a segment list in the segment routing header;
an attribute module configured to identify from the tag an attribute set comprising one or more in-band telemetry attributes to be collected from the node; and
a telemetry write module configured to write the in-band telemetry attributes of the attribute set to a location of a current segment address of a segment list of the segment routing header, the current segment address corresponding to the node,
wherein at least a portion of said modules comprise one or more of hardware circuits, programmable hardware circuits and executable code, the executable code stored on one or more non-transitory computer readable storage media.

2. The apparatus of claim 1, further comprising:
a segment address module configured to, prior to the telemetry write module writing the in-band telemetry attributes to the location of the current segment address, extract a next segment address from the segment list of a next node in the communication pathway and to write the next segment address to a destination internet protocol (“IP”) address, wherein the next segment address of the segment list corresponds to a segments left of a segments left field;
a counter decrement module configured to decrement the segments left in the segment routing header in response to the telemetry write module writing the in-band telemetry attributes; and
a packet processing module configured to, in response to the counter decrement module decrementing the segments left, forward the data packet to a next node corresponding to the next segment address in response to the segments left being greater than zero and to process the data packet in response to the segments left being zero.

3. The apparatus of claim 2, further comprising a telemetry bypass module configured to bypass the telemetry write module writing the in-band telemetry attributes in response to the tag comprising a zero or a value not corresponding to an attribute set.

4. The apparatus of claim 1, wherein the tag in the tag field comprises one of a plurality of tags for the communication pathway, each of the plurality of tags corresponding to an attribute set of in-band telemetry attributes to be collected from the node, wherein the attribute sets corresponding to the plurality of tags comprising a total set of in-band telemetry data to be collected from the node.

5. The apparatus of claim 4, wherein a number of tags for the plurality of tags is determined based on a size of the total set of in-band telemetry data divided by a size of locations in the segment list.

6. The apparatus of claim 4, wherein an ingress node adds a first tag of the plurality of tags to a first packet in a flow of packets traversing the communication pathway, and adds subsequent tags of the plurality of tags to subsequent packets in the communication pathway up to a last tag in the plurality of tags and wherein the ingress node repeats adding tags in a same sequence to additional packet until a last packet of the flow of packets is sent by the ingress node.

7. The apparatus of claim 1, wherein the attribute set is sized to fit in the location of the current segment address.

8. The apparatus of claim 1, wherein the in-band telemetry attributes of the attribute set comprise a hop latency, ingress queue occupancy, egress queue occupancy, Egress Interface Tx Utilization, buffer occupancy, ingress queue number, and/or egress queue number.

9. An apparatus comprising:
a telemetry receiver module configured to receive, at an ingress node, telemetry instructions from a network controller, the telemetry instructions comprising an attribute set comprising one or more in-band telemetry attributes to be collected from nodes along a communication pathway from the ingress node to an egress node by data packets of a source routing packet flow traversing the communication pathway;
a tag field module configured to write a tag to a tag field of a segment routing header of a data packet of the source routing packet flow, the tag corresponding to the attribute set; and
a packet transmission module configured to transmit the data packet to a destination IP address of a next node in the communication pathway, the destination IP address corresponding to a segment address from a segment list in the segment routing header of the data packet,
wherein at least a portion of said modules comprise one or more of hardware circuits, programmable hardware circuits and executable code, the executable code stored on one or more non-transitory computer readable storage media.

10. The apparatus of claim 9, wherein the attribute set comprises a total attribute set, the total attribute set comprising a plurality of in-band telemetry attributes with a size larger than a size of a location in the segment list and further comprising:
an attribute division module configured to divide the total attribute set into a plurality of attribute sets;
a tag assignment module configured to assign a tag to each of the plurality of attribute sets; and/or
an ingress telemetry module configured to write in-band telemetry attributes associated with the tag to a Type Length Value objects field of the segment routing header of the data packet.

11. The apparatus of claim 10, further comprising a rolling tag module configured to write a tag corresponding to each of the plurality of attribute sets to the tag field of the segment routing header of subsequent data packets of the source routing packet flow in a rolling sequence prior to transmitting the data packets of the source routing packet flow to a next node.

12. The apparatus of claim 11, wherein the rolling tag module comprises:
an in-band telemetry (“INT”) counter module configured to increment an INT counter in response to determining that the data packet is part of the source routing packet flow; and
an INT limit module configured to determine if the INT counter is greater than or equal to an INT limit, the INT limit corresponding to a number of the plurality of attribute sets,
wherein the tag field module is further configured to write a tag to the tag field of the segment routing header, the tag corresponding to the INT counter after incrementing by the INT counter module.

13. The apparatus of claim 12, wherein the rolling tag module further comprises:
a new flow module configured to determine if the data packet is of a new source routing packet flow; and
an INT counter reset module configured to reset the INT counter to zero in response to the new flow module determining that the data packet is of a new source routing packet flow and in response to the INT limit module determining that the INT counter is greater than or equal to the INT limit,
wherein the tag field module is configured to write a tag to the tag field corresponding to an INT counter value of zero.

14. A method comprising:
reading a tag of a tag field of a segment routing header of a data packet received at a node along a communication pathway, the communication pathway described in a segment list in the segment routing header;
identifying from the tag an attribute set comprising one or more in-band telemetry attributes to be collected from the node; and
writing the in-band telemetry attributes of the attribute set to a location of a current segment address of a segment list of the segment routing header, the current segment address corresponding to the node.

15. The method of claim 14, further comprising:
prior to writing the in-band telemetry attributes to the location of the current segment address, extracting a next segment address from the segment list of a next node in the communication pathway and to writing the next segment address to a destination internet protocol (“IP”) address, wherein the next segment address of the segment list corresponds to a segments left of a segments left field;
decrementing the segments left in the segment routing header in response to writing the in-band telemetry attributes; and
in response to decrementing the segments left, forwarding the data packet to a next node corresponding to the next segment address in response to the segments left being greater than zero and processing the data packet in response to the segments left being zero.

16. The method of claim 15, further comprising bypassing writing the in-band telemetry attributes in response to the tag comprising a zero or a value not corresponding to an attribute set.

17. The method of claim 14, wherein the tag in the tag field comprises one of a plurality of tags for the communication pathway, each of the plurality of tags corresponding to an attribute set of in-band telemetry attributes to be collected from the node, wherein the attribute sets corresponding to the plurality of tags comprising a total set of in-band telemetry data to be collected from the node.

18. The method of claim 17, wherein a number of tags for the plurality of tags is determined based on a size of the total set of in-band telemetry data divided by a size of locations in the segment list and/or wherein an ingress node adds a first tag of the plurality of tags to a first packet in a flow of packets traversing the communication pathway, and adds subsequent tags of the plurality of tags to subsequent packets in the communication pathway up to a last tag in the plurality of tags and wherein the ingress node repeats adding tags in a same sequence to additional packet until a last packet of the flow of packets is sent by the ingress node.

19. A method comprising:
receiving, at an ingress node, telemetry instructions from a network controller, the telemetry instructions comprising an attribute set comprising one or more in-band telemetry attributes to be collected from nodes along a communication pathway from the ingress node to an egress node by data packets of a source routing packet flow traversing the communication pathway;
writing a tag to a tag field of a segment routing header of a data packet of the source routing packet flow, the tag corresponding to the attribute set; and
transmitting the data packet to a destination IP address of a next node in the communication pathway, the destination IP address corresponding to a segment address from a segment list in the segment routing header of the data packet.

20. The method of claim 19, wherein the attribute set comprises a total attribute set, the total attribute set comprising a plurality of in-band telemetry attributes with a size larger than a size of a location in the segment list and further comprising:
dividing the total attribute set into a plurality of attribute sets;
assigning a tag to each of the plurality of attribute sets; and/or
writing in-band telemetry attributes associated with the tag to a Type Length Value objects field of the segment routing header of the data packet.

21. The method of claim 20, further comprising writing a tag corresponding to each of the plurality of attribute sets to the tag field of the source routing header of subsequent data packets of the source routing packet flow in a rolling sequence prior to transmitting the data packets of the source routing packet flow to a next node.

22. The method of claim 21, further comprising:
incrementing an in-band telemetry (“INT”) counter in response to determining that the data packet is part of the source routing packet flow;
determining if the INT counter is greater than or equal to an INT limit, the INT limit corresponding to a number of the plurality of attribute sets; and/or
writing a tag to the tag field of the segment routing header, the tag corresponding to the INT counter after incrementing.

23. The method of claim 22, further comprising:
determining if the data packet is of a new source routing packet flow;
resetting the INT counter to zero in response to determining that the data packet is of a new source routing packet flow and in response to determining that the INT counter is greater than or equal to the INT limit; and
writing a tag to the tag field corresponding to an INT counter value of zero.
